(19) United States
(12) Patent Application Publication
(10) Pub. No.: US 2023/0308807 A1
(43) Pub. Date: Sep. 28, 2023

(54) MICRO-SPEAKER DEVICE AND DAMPER FOR MICRO-SPEAKER DEVICES

(71) Applicant: Vanson Electronics (Nanhai) Co., Ltd., Foshan City (CN)

(72) Inventor: Hao-Chien Hsu, Taipei City (TW)

(73) Assignee: Vanson Electronics (Nanhai) Co., Ltd., Foshan City (CN)

(21) Appl. No.: 17/961,541

(22) Filed: Oct. 6, 2022

(30) Foreign Application Priority Data
Mar. 22, 2022 (CN) 202210286731.1

(51) Int. Cl. H04R 9/04; H04R 9/02

(52) U.S. Cl. CPC H04R 9/043; H04R 9/025

(57) ABSTRACT

A micro-speaker includes a frame, a diaphragm on the frame, a magnetic structure and a voice coil in the frame, and upper side of the voice coil is fixedly connected to the diaphragm. The magnetic structure is arranged below the voice coil. A voice coil balance system is arranged in the frame, which is composed of two symmetrically arranged dampers, which are respectively arranged below two ends of the long axis of the voice coil, and fixed with glue. The damper includes a first end portion, a second end portion and a cantilever connecting the first end portion and the second end portion. The cantilever extended from the first end portion has a curved shape, with at least one arc greater than or equal to 180 degrees, and at least one inflection point that makes the curved cantilever turn from convex to concave or from concave to convex.

### BACKGROUND OF THE INVENTION

### 1. Field of the Invention

The invention relates to the technical field of speaker devices, in particular to a micro-speaker device and a damper for the micro-speaker device.

### 2. Description of the Prior Art

A loudspeaker is a kind of transducer element that converts electrical signals into acoustic signals, and is an important acoustic component in electronic products. The micro-speaker module usually includes a frame and a magnetic system and a vibration system disposed within the frame. The vibration system includes a diaphragm and a voice coil arranged under the diaphragm. The voice coil drives the diaphragm to produce sound under the vibration of the magnetic system.

With the high pursuit of portability of electronic products, volume reduction is a necessary goal when updating various micro-speaker products, but the reduction in volume means that the size of the magnets of the micro-speaker must be reduced at the same time, resulting in a decrease in volume. If the volume drop caused by the smaller magnet is compensated by increasing the power, the micro-speaker faces the risk of breaking the voice coil lead due to the excessive amplitude.

### SUMMARY OF THE INVENTION

It is one object of the present invention to provide a micro-speaker and a damper for the micro-speaker, so as to solve the above-mentioned problems in the background art.

To achieve the above object, the present invention provides the following technical solutions:

One aspect of the invention provides a micro-speaker including a frame, a diaphragm disposed on the frame, a magnetic structure and a voice coil disposed in the frame, wherein an upper side of the voice coil is fixedly connected to the diaphragm, and the magnetic structure is disposed below the voice coil, the micro-speaker is characterized in that a voice coil balance system is arranged in the frame, the voice coil balance system is composed of two symmetrically arranged dampers, which are respectively arranged below two ends of a long axis of the voice coil, and fixed with glue, wherein each of the dampers comprises a first end portion, a second end and a cantilever connecting the first end portion and the second end, wherein the cantilever extended from the first end portion is of a shape of a curve, having at least one arc greater than or equal to 180 degrees, and having at least one inflection point that turns the curved cantilever from convex to concave or from concave to convex.

According to some embodiments, the damper has a left-right symmetrical structure.

According to some embodiments, a ratio L/D of length L of the cantilever to distribution distance D of the cantilever is between 2 and 15.

According to some embodiments, an angle between the first end portion and the cantilever extending from the first end portion is between 30-150 degrees.

According to some embodiments, a positioning pillar is provided on the frame, and a corresponding positioning hole is provided on the damper.

According to some embodiments, when installing the damper, the positioning pillar on the frame passes through the corresponding positioning hole on the damper to achieve accurate position.

According to some embodiments, the cantilever has a width of 0.45 mm.

According to some embodiments, the diaphragm is set in an elongated shape, and a dimension in lengthwise direction is larger than a dimension in widthwise direction.

According to some embodiments, the frame has an opening adapted to the shape of the diaphragm, and the diaphragm is connected to the frame through an annular surround, to seal the opening.

According to some embodiments, the magnetic structure comprises a main magnetic part, a yoke located under the main magnetic part, and a washer on the main magnetic part, wherein the voice coil is sleeved on an outer periphery of the main magnetic part.

According to some embodiments, the yoke includes a foot, which is in contact with the second end portion of the damper.

According to some embodiments, the damper is fixed under two ends of the long axis of the voice coil through the first end portion with adhesive, and is fixed below two ends of the long axis of the frame with adhesive through the second end portion, and a width of the second end portion adhered to bottom of the two ends of the long axis of the frame is larger than a width of the first end portion adhered to bottom of both ends of the long axis of the voice coil.

Another aspect of the invention provides a damper for a micro-speaker including a first end portion, a second end portion, and a cantilever connecting the first end portion and the second end portion, wherein the cantilever extending from the first end portion has a curved shape, with at least one arc greater than or equal to 180 degrees, and with at least one inflection point that makes the curved cantilever turn from convex to concave or from concave to convex.

According to some embodiments, the damper has a left-right symmetrical structure.

According to some embodiments, a ratio L/D of the length L of the cantilever to a distribution distance D of the cantilever is between 2 and 15.

According to some embodiments, the damper is formed by a flexible printed circuit board.

According to some embodiments, an angle between the first end portion and the cantilever extending from the first end portion is between 30-150 degrees.

According to some embodiments, a width of the second end portion is greater than a width of the first end portion.

According to some embodiments, the cantilever has a width of 0.45 mm.

Compared with the prior art, the beneficial effect of the present invention is: by arranging the damper formed by the flexible printed circuit board on the voice coil, sufficient elasticity and damping can be provided to reduce the vibration of the lead wire of the voice coil, thereby increasing the rated power, as well as life testing under high power operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the appearance of the bottom of a micro-speaker according to an embodiment of the present invention.

FIG. 2 is an exploded view of the micro-speaker of FIG. 1.

FIG. 3 illustrates a schematic layout of a damper.

FIG. 4 is a side view of the damper seen with part of the yoke removed.

### DETAILED DESCRIPTION

In order to make the objectives, technical solutions, and advantages of the embodiments of the present invention clearer, the technical solutions in the embodiments of the present invention will be described clearly and completely in conjunction with the accompanying drawings in the embodiments of the present invention. Obviously, the described embodiments are part of the embodiments of the present invention, but not all of the embodiments. Based on the embodiments of the present invention, all other embodiments obtained by those of ordinary skill in the art without creative work shall fall within the protection scope of the present invention. Therefore, the following detailed description of the embodiments of the present invention provided in the accompanying drawings is not intended to limit the scope of the claimed invention, but merely represents selected embodiments of the present invention.

In the description of the present invention, it should be understood that the terms “center”, “longitudinal”, “transverse”, “length”, “width”, “thickness”, “upper”, “lower”, “front”, “back”, “left”, “Right”, “vertical”, “horizontal”, “top”, “bottom”, “inner”, “outer”, “clockwise”, “counterclockwise” and other directions or the positional relationship are based on the orientation or positional relationship shown in the drawings, and is only for the convenience of describing the present invention and simplifying the description, and does not indicate or imply that the pointed device or element must have a specific orientation, be constructed and operated in a specific orientation, Therefore, it shall not be interpreted as a limitation to the present invention.

In the present invention, unless otherwise clearly defined and specified, the “above” or “below” of the first feature of the second feature may include direct contact between the first and second features, or may include the first and second features not in direct contact but through other features between them. Moreover, “above”, “above” and “above” the second feature of the first feature include the first feature being directly above and obliquely above the second feature, or it simply means that the first feature is higher in level than the second feature. The “below”, “below” and “below” of the second feature of the first feature include the first feature directly below and obliquely below the second feature, or it simply means that the level of the first feature is smaller than the second feature.

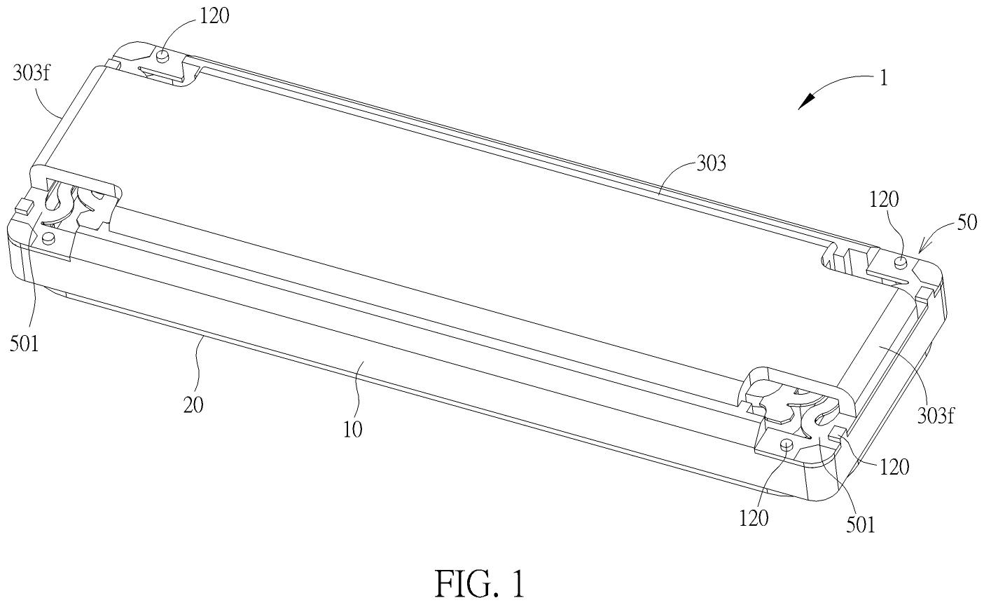

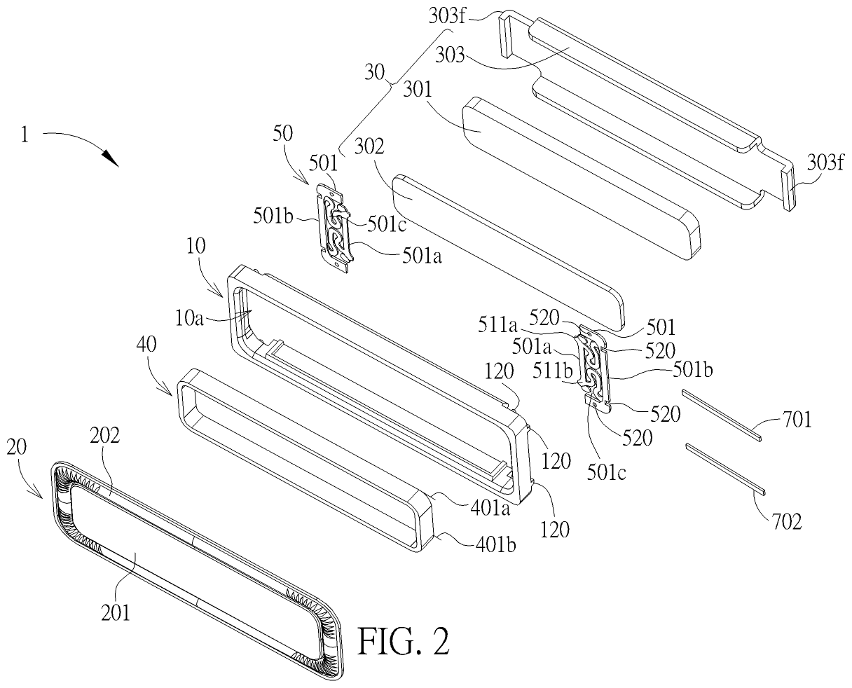

Please refer to FIG. 1 and FIG. 2. FIG. 1 is a schematic diagram of the appearance of the bottom of the micro-speaker according to an embodiment of the present invention. FIG. 2 is an exploded view of the micro-speaker of FIG. 1. As shown in FIG. 1 and FIG. 2, according to an embodiment of the present invention, the micro-speaker 1 includes a frame 10 and a drum paper 20 provided on the frame 10. According to an embodiment of the present invention, the drum paper 20 may include a diaphragm 201 and a surround 202 surrounding the diaphragm 201 and having an arc-shaped or wavy cross-section. According to an embodiment of the present invention, the diaphragm 201 and the surround 202 may be formed of different materials, but are not limited thereto.

According to an embodiment of the present invention, preferably, the drum paper 20 is flexibly connected to one end of the frame 10. According to an embodiment of the present invention, the diaphragm 201 is arranged in an elongated shape, that is, its dimension in the lengthwise direction is larger than that in the widthwise direction. According to an embodiment of the present invention, the frame 10 has an opening 10a adapted to the shape of the drum paper 20 and the diaphragm 201, and the diaphragm 201 is connected to the frame 10 through an annular surround 202 to seal the opening 10a. According to an embodiment of the present invention, a magnetic structure 30 is disposed in the frame 10, including a main magnetic portion 301, a washer 302 arranged around one side of the main magnetic portion 301, and a yoke 303 disposed on the other side of the main magnetic portion 301.

According to an embodiment of the present invention, a voice coil 40 is disposed in the frame 10. According to an embodiment of the present invention, the voice coil 40 is formed by winding an enameled wire, and a bobbin is not required. The voice coil 40 is sleeved on the outer periphery of the main magnetic part 301. According to an embodiment of the present invention, the voice coil 40 is set in an elongated shape, that is, the size in the lengthwise direction is larger than the size in the widthwise direction, and the upper end of the voice coil 40 is fixedly connected to the diaphragm 201. Preferably, in some embodiments of the present invention, the center of the voice coil 40 is located on the central axis in the lengthwise direction of the diaphragm 201. A magnetic field is provided through the magnetic structure 30 to make the voice coil 40 vibrate, and the diaphragm 201 is driven to produce sound.

According to an embodiment of the present invention, a voice coil balance system 50 is disposed in the frame 10, which is mainly composed of two symmetrically arranged dampers 501. According to an embodiment of the present invention, one end of each damper 501 is disposed below one end of the long axis of the voice coil 40, and is fixed with glue. According to an embodiment of the present invention, the damper 501 may be formed of a flexible printed circuit (FPC) board, but is not limited thereto.

According to an embodiment of the present invention, the damper 501 generally includes a first end portion 501a, a second end portion 501b, and a cantilever 501c connecting the first end portion 501a and the second end portion 501b. Between the first end portion 501a, the second end portion 501b and the cantilever 501c is a hollow portion. The dampers 501 are fixed under opposite ends of the long axis of the voice coil 401 through the first end portion 501a with adhesive, and are fixed under the two ends of the long axis of the frame 10 through the second end portion 501b. The voice coil leads 401a and 401b are respectively fixedly connected to the welding parts 511a and 511b of the first end portion 501a on the front side of the damper 501 through electric spot welding, and are electrically connected to the circuit on the bottom surface of the damper 501, and pass through the upper surface of the damper 501. The circuit is further electrically connected to the connection terminal on the bottom surface of the second end portion 501b.

According to an embodiment of the present invention, the connection terminals on the bottom surface of the second end portion 501b are respectively welded with external signal wires 701 and 702 to connect with the external devices, so as to input the external sound source signal through the damper 501, so that the diaphragm 201 vibrates and produces sound. According to an embodiment of the present invention, when the damper 501 is installed, accurate positioning can be achieved through the positioning pillars 120 on the frame 10 and the corresponding positioning hole 520 on the damper 501.

According to an embodiment of the present invention, the length of the yoke 303 is approximately equal to the length of the frame 10. According to an embodiment of the present invention, the yoke 303 includes feet 303f at both ends, for example, fixed to the second end portion 501b of the damper 501 by adhesive. By using the feet 303f at both ends of the yoke 303 to press the second end portion 501b of the damper 501, the stability of the damper 501 during operation can be improved.

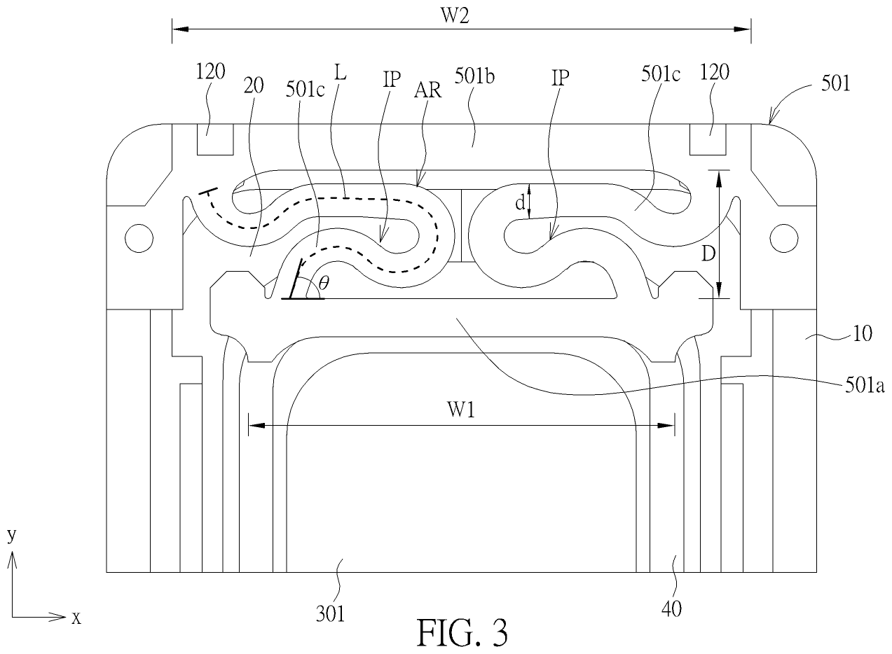

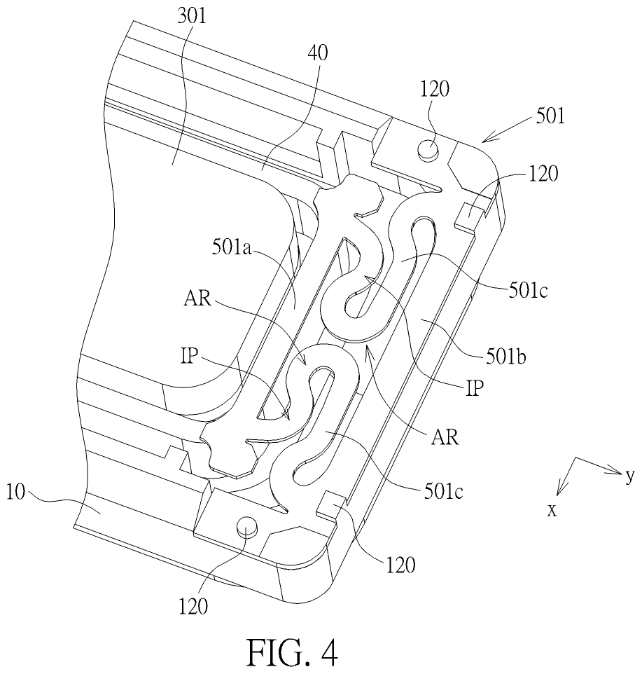

See FIG. 3 and FIG. 4. FIG. 3 illustrates a schematic layout of the damper 501, and FIG. 4 is a side perspective view of the damper 501 after removing part of the yoke 303. As shown in FIG. 3 and FIG. 4, the damper 501 has two cantilevers 501c, and has a left-right symmetrical structure. The first end portion 501a and the second end portion 501b of the damper 501 are both parallel to the reference x-axis direction, and the two cantilevers 501c are interposed between the first end portion 501a and the second end portion 501b, meandering toward the reference x-axis direction or the reference y-axis direction. According to an embodiment of the present invention, in order to enable the damper 501 to provide sufficient elasticity and damping, the cantilever 501c has a curved shape and has at least one arc AR greater than or equal to 180 degrees, and has at least one inflection point IP that makes the curve turn from concave to convex (or from convex to concave). In addition, the angle θ between the cantilever 501c extending from the first end portion 501a and the first end portion 501a adhered to the lower part of the voice coil 40 may be between 30-150 degrees, so as to reduce the torque acting on the cantilever 501c to improve the stability of the cantilever 501c. The cantilever 501c starts from the first end portion 501a, and the centerline of the cantilever is taken as the criterion, and part of the cantilever 501c will advance toward the reference y-axis direction. According to an embodiment of the present invention, in order to increase the stability and balance of the damper 501 during operation, the width W2 of the second end portion 501b attached to the lower part of the frame 10 is greater than the width W1 of the first end portion 501a attached to the lower part of the voice coil 40.

According to an embodiment of the present invention, the cantilever distribution distance D refers to the width of the serpentine or curved cantilevers 501c distributed between the first end portion 501a and the second end portion 501b. According to an embodiment of the present invention, taking the cantilever width d of 0.45 mm as an example, the ratio L/D between the extension length L of the cantilever 501c between the first end portion 501a and the second end portion 501b and the cantilever distribution distance D needs to be between 2 and 15.

It is advantageous to use the present invention because by setting two independent dampers 501 as a medium, the amplitude of the voice coil originally borne by the voice coil leads is changed to be borne by the dampers 501. The damper 501 can provide sufficient elasticity and damping, so that the micro-speaker can also bear the amplitude brought by high power, thereby increasing the rated power (even in the case of reduced volume, it can still provide high sound volume). The life test under high power operation is improved. In addition, the shape, pattern and thickness of the two independent dampers 501 can be adjusted according to the vibration mode of the diaphragm 201, thereby optimizing the vibration behavior of the micro-speaker to provide better sound quality. During the manufacturing process, the two independent dampers 501 can be connected to the frame 10 first as a semi-finished product, which will simplify the complexity of the assembly and manufacturing process of the micro-speaker.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A micro-speaker comprising a frame, a diaphragm disposed on the frame, a magnetic structure and a voice coil disposed in the frame, wherein an upper side of the voice coil is fixedly connected to the diaphragm, and the magnetic structure is disposed below the voice coil, the micro-speaker is characterized in that a voice coil balance system is arranged in the frame, the voice coil balance system is composed of two symmetrically arranged dampers, which are respectively arranged below two ends of a long axis of the voice coil, and fixed with glue, wherein each of the dampers comprises a first end portion, a second end portion and a cantilever connecting the first end portion and the second end portion, wherein the cantilever extended from the first end portion is of a shape of a curve, having at least one arc greater than or equal to 180 degrees, and having at least one inflection point that turns the curve from convex to concave or from concave to convex.

2. The micro-speaker according to claim 1, wherein the damper has a left-right symmetrical structure.

3. The micro-speaker according to claim 1, wherein a ratio L/D of length L of the cantilever to distribution distance D of the cantilever is between 2 and 15.

4. The micro-speaker according to claim 1, wherein an angle between the first end portion and the cantilever extending from the first end portion is between 30-150 degrees.

5. The micro-speaker according to claim 1, wherein a positioning pillar is provided on the frame and a corresponding positioning hole is provided on the damper.

6. The micro-speaker according to claim 5, wherein when installing the damper, the positioning pillar on the frame passes through the corresponding positioning hole on the damper to achieve accurate position.

7. The micro-speaker according to claim 1, wherein the cantilever has a width of 0.45 mm.

8. The micro-speaker according to claim 1, wherein the diaphragm is set in an elongated shape, and a dimension in lengthwise direction is larger than a dimension in widthwise direction.

9. The micro-speaker according to claim 8, wherein the frame has an opening adapted to the shape of the diaphragm, and the diaphragm is connected to the frame through an annular surround, to seal the opening.

10. The micro-speaker according to claim 1, wherein the magnetic structure comprises a main magnetic part, a yoke located under the main magnetic part, and a washer on the main magnetic part, wherein the voice coil is sleeved on an outer periphery of the main magnetic part.

11. The micro-speaker according to claim 10, wherein the yoke includes a foot, which is in contact with the second end portion of the damper.

12. The micro-speaker according to claim 1, wherein the damper is fixed under two ends of the long axis of the voice coil through the first end portion with adhesive, and is fixed below two ends of the long axis of the frame with adhesive through the second end portion, and a width of the second end portion adhered to bottom of the two ends of the long axis of the frame is larger than a width of the first end portion adhered to bottom of both ends of the long axis of the voice coil.

13. A damper for a micro-speaker, comprising: a first end portion, a second end portion, and a cantilever connecting the first end portion and the second end portion, wherein the cantilever extending from the first end portion has a curved shape, with at least one arc greater than or equal to 180 degrees, and with at least one inflection point that makes the curved cantilever turn from convex to concave or from concave to convex.

14. The damper for a micro-speaker according to claim 13, wherein the damper has a left-right symmetrical structure.

15. The damper for a micro-speaker according to claim 13, wherein a ratio L/D of the length L of the cantilever to a distribution distance D of the cantilever is between 2 and 15.

16. The damper for a micro-speaker according to claim 13, wherein the damper is formed by a flexible printed circuit board.

17. The damper for a micro-speaker according to claim 13, wherein an angle between the first end portion and the cantilever extending from the first end portion is between 30-150 degrees.

18. The damper for a micro-speaker according to claim 13, wherein a width of the second end portion is greater than a width of the first end portion.

19. The damper for a micro-speaker according to claim 13, wherein the cantilever has a width of 0.45 mm.
